(19) United States
(12) Patent Application Publication
(10) Pub. No.: US 2003/0000161 A1
(43) Pub. Date: Jan. 2, 2003

(54) Device for fastening a cover on parts of doors and partitions

(75) Inventor: Wilfried Kletscher, Bad Salzuflen (DE)

Correspondence Address: COHEN, PONTANI, LIEBERMAN & PAVANE, 551 FIFTH AVENUE, SUITE 1210, NEW YORK, NY, 10176, US

(73) Assignee: DORMA GmbH+Co. KG

(21) Appl. No.: 10/186,576

(22) Filed: Jul. 1, 2002

(30) Foreign Application Priority Data
Jun. 29, 2001 (DE) 101 31 263.6

(51) Int. Cl. E06B 1/04

(52) U.S. Cl. 52/204.1

(57) ABSTRACT

A device for a door or partition, especially a glass panel, includes a part for fitting to the door or partition, a cover for fitting to the part, and a hook and pile fastener joining the part and the cover.

### BACKGROUND OF THE INVENTION

1. Field of the Invention

The invention concerns the fastening of a cover on parts of doors and partitions, especially glass panels, such as fittings, door handles, door locks, door tracks, and the like.

2. Description of the Related Art

Covers or crowning caps of the sort mentioned above are used in the whole range of technology related to the designing of doors and partitions of all kinds. This applies both to devices that allow movement of neighboring parts relative to each other, such as fittings and strips, and to devices that join or support doors or partitions, especially glass panels, such as joining fittings or door tracks, as well as to accessories, such as rosettes or escutcheons on door handles and door locks. The crowning covers prevent dirt from entering the part itself, eliminate the risk of injury, especially in the case of parts that move relative to each other, and improve the visual effect of the given part.

Previously known covers are generally fastened on the associated part by screw connections, but this requires the expensive production of precisely fitted bores or possibly tapped bores.

Therefore, there has been a partial conversion to the use of clip fasteners to secure covers on the corresponding parts. However, this requires the placement of complementary projections and recesses in both the cover and the corresponding part, which likewise results in cost-intensive production.

### SUMMARY OF THE INVENTION

The invention provides a cost-effective device for fastening a cover onto a part without the use of a screw connection and without the use of a clip connection that solely secures the cover on the part. The fastening device is easy to install and remove, and can be used with practically all conceivable generic parts.

In accordance with the invention, a part for fitting to a door or partition and a cover are joined by a hook and pile fastener.

By using a hook and pile (Velcro-type) fastener, the advantage gained by the sole use of clip fasteners, namely, an improved visual effect compared to the use of a screw connection, is also obtained here, as well as the additional advantage that the manner of fastening is not outwardly apparent. The simple detachability of the cover is exclusively an advantage, since the cover is not a part associated with safety issues with respect to its operation.

In a refinement of the invention, the complementary parts of the hook and pile fastener are cemented to the part as well as to the cover. To produce the connection between one element of the fastener and the part itself, other possibilities basically remain open, such as a screw connection; although this would still provide the advantage of easy attachment and detachment, it would disturb the visual effect.

If covers needed to cover certain parts are designed with a curved shape, i.e., for example, a shape that is convex outward, it is further proposed, in accordance with the invention, that a spacer that is cemented to both the cover and the Velcro-type fastener be placed in the arched region between the cover and the Velcro-type fastener. By choosing a suitable spacer of appropriate thickness, one can attach practically any type of cover of any shape to the given part by means of a Velcro-type fastener. The cover and/or the spacer may be made of metal or plastic. Any desired metallic materials may be used, such as aluminum, high-grade steel, or brass.

In individual cases, for example, in the fashioning of a floor or ceiling track to be described below, it may be advantageous to fasten the cover to the part by combination of a mechanical, screwless locking device; in this case, to realize a mechanical, screwless catch in the form of a clip fastener, it is only necessary to develop a simple catch on the lower track, into which a corresponding edge of the cover can be inserted so that it grips it from behind.

The invention will now be explained in greater detail with reference to three specific embodiments.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a perspective view of a cover of a lower track of a glass door or glass panel;

FIG. 2 is a perspective view of a cover of a door lock;

FIG. 2A is partial section view of the cover of FIG. 2; and

FIG. 3 is a cover of a fitting in the fonn of a lower support.

### DETAILED DESCRIPTION OF THE PRESENTLY PREFERRED EMBODIMENTS

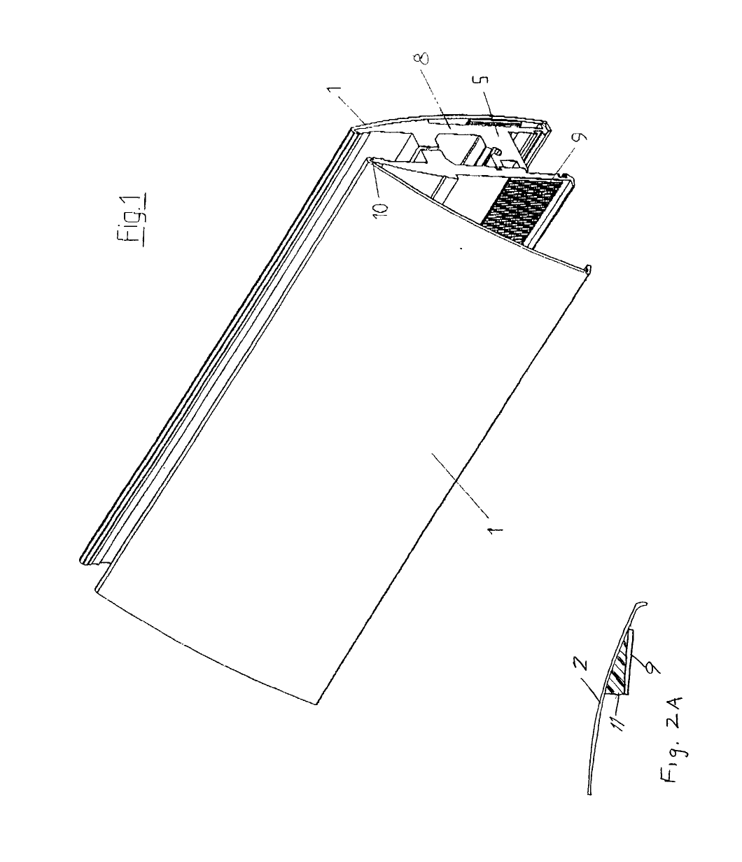

Referring to FIG. 1, a door track 5 is covered on both sides by a cover 1. The cover 1 grips a sidepiece 8 of the door track 5 from behind by means of a screwless catch 10 and can be detachably secured on the door track 5 by a hook and pile (Velcro-type) fastener 9. The complementary part of the fastener 9 is mounted on the inside of the cover 1.

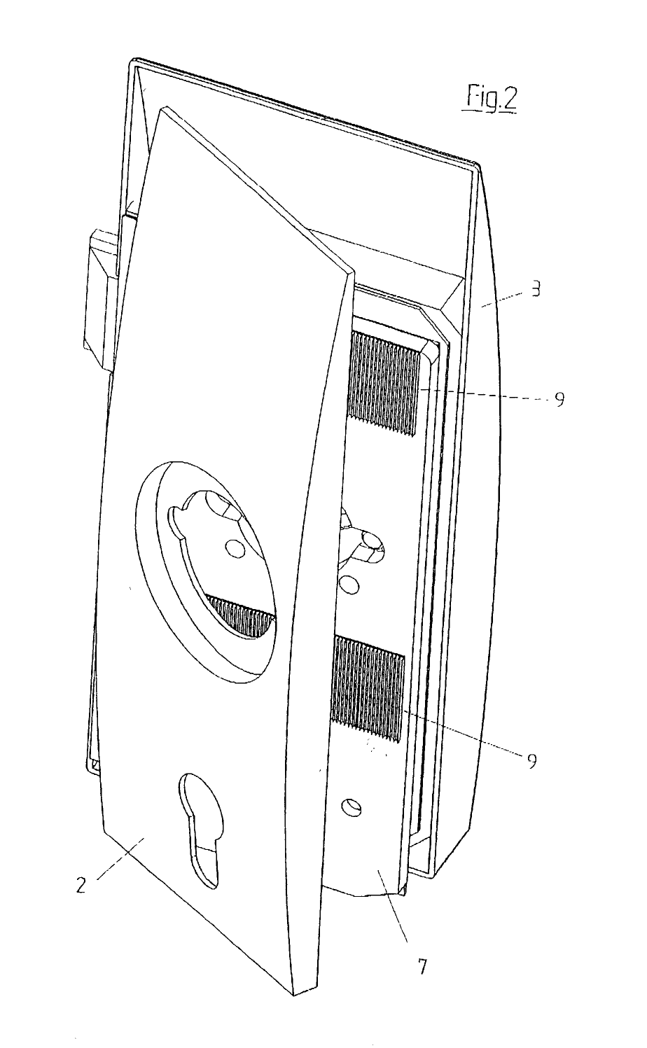

In FIG. 2, the covers 2 and 3 are likewise held on a door lock 7 by means of hook and pile fasteners 9 mounted on the door lock 7, and the complementary parts of the fasteners 9 are again mounted on the insides of the covers 2 and 3 that face the door lock 7. Due to the convex shape of the covers 2 and 3, it is necessary to insert a spacer 11 (FIG. 2A) between the complementary part of the fastener 9 and the inside walls of covers 2 and 3 to ensure flat mounting of the complementary parts of the fastener 9.

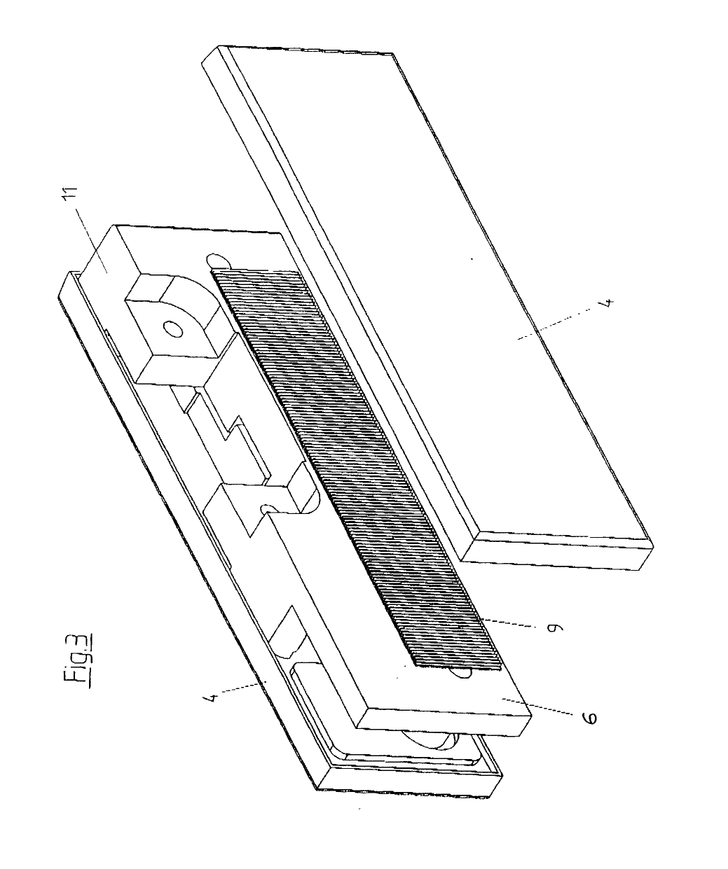

In FIG. 3, the fitting 6 is a lower support having an attaching feature 11 for attaching an associated fitting. The outer covers 4 of the fitting 6 are caplike covers which are attached, as shown in the drawing, by a cemented hook and pile fastener 9.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. A device for a door or partition comprising
a part for fitting to one of a door and a partition,
a cover for fitting to said part, and
a hook and pile fastener joining said part and said cover.

2. A device as in claim 1 wherein said hook and pile fastener comprises complementary parts cemented to said part and said cover respectively.

3. A device as in claim 2 wherein said cover is outwardly convex, said device further comprising a spacer cemented to said cover, one of said complementary parts of said hook and pile fastener being cemented to said spacer.

4. A device as in claim 1 wherein at least one of said part and said cover is made of plastic.

5. A device as in claim 1 wherein said cover further comprises a screwless catch for fastening said cover to said part.

6. A device as in claim 1 wherein said device is one of a fitting, a door handle, a door lock, and a door track.
